(19) United States
(12) Patent Application Publication
(10) Pub. No.: US 2010/0275479 A1
(43) Pub. Date: Nov. 4, 2010

(54) TENSILE STRUCTURE AND METHOD OF ERECTION

(75) Inventors: Phill Reynolds, Cheshire (GB); G. Roland Hill, Cheshire (GB)

Correspondence Address: PILLSBURY WINTHROP SHAW PITTMAN, LLP, P.O. BOX 10500, MCLEAN, VA, 22102, US

(73) Assignee: CESTRIAN IMAGING LIMITED, Cheadle Hulme, Cheshire (GB)

(21) Appl. No.: 12/678,584

(22) PCT Filed: Sep. 17, 2008
(86) PCT No.: PCT/GB2008/003146

§ 371 Date: Jun. 29, 2010

Related U.S. Application Data
(60) Provisional application No. 60/972,880, filed on Sep. 17, 2007.

(51) Int. Cl. G09F 15/02; A44B 99/00; B23P 17/04

(52) U.S. Cl. 40/603; 24/302; 24/301; 29/897

(57) ABSTRACT

A tensile structural assembly includes a base support, guide hook, loop, and tie. The guide hook is fixed to the base support and includes a guide section and hook section. The guide section includes a length of substantially uniform width. The loop attaches to or forms part of the tie. The guide hook retains the loop. The loop and the tie are in tension. In one embodiment; the tensile structure may be assembled by fixing the guide hook to the base support, temporarily locating the loop in an application tool recess of an application tool, temporarily locating the application tool over the guide section, and applying a force to the application tool, which moves the loop along the guide section imparting tension into said loop and the tie, until the loop moves to the end of the hook section and snaps into the hook section, retaining the loop and the tie in tension.

### FIELD OF THE INVENTION

This invention relates to tensioned structures, for example tensile fabric or filmic structures, for example for billboards, shelters and canopies and tensioned linear structures.

### BACKGROUND TO THE INVENTION

Tensioned fabric and filmic structures are well known, for example to provide shelter from rain or sun. Tensioned fabric or filmic printed materials for billboards are also known, including framing systems providing retention and optionally tensioning of the printed material. Elasticated materials are known including elastic cord sometimes referred to as “shock cord” or “bungee cord”. Means of structural connections to fabrics or films are also known, for example eyelet holes with annular metal reinforcers, or gripper devices, for example Holdon™ two-part gripper devices, or edge seams containing cable. These are used to distribute local stresses in fabric or filmic structures, for example at the connection points to associated tensioned cables, springs or tie rods, for example tie rods comprising a turnbuckle tensioning device.

### SUMMARY OF THE INVENTION

According to one aspect of one or more embodiments of the present invention, a tensile structural assembly comprises a base support, a guide hook, a loop and a tie, wherein said guide hook is fixed to said base support, wherein said guide hook comprises a guide section and a hook section, wherein said guide section comprises an elongate section, wherein said loop is attached to or forms part of said tie, wherein said loop is retained by said guide hook, and wherein said loop and said tie are in tensile stress.

According to a second aspect of one or more embodiments of the invention, there is a method of assembling a tensile structural assembly comprising a base support, a guide hook, a loop and a tie, wherein said guide hook is fixed to said base support, wherein said guide hook comprises a guide section and a hook section, wherein said guide section comprises an elongate section, wherein said loop is attached to or forms part of said tie, wherein said loop is retained by said guide hook, and wherein said loop and said tie are in tensile stress, wherein said method uses an application tool comprising a recess, said method comprising the steps of:
(i) fixing said guide hook to said base support,
(ii) temporarily locating said loop in said application tool recess,
(iii) temporarily locating said application tool over said guide section,
(iv) applying a force to said application tool which moves the loop along the guide section imparting tension into said loop and said tie, until said loop is moved to the end of said hook section and snaps back within said hook section, retaining said loop and said tie in tension.

According to a third aspect of one or more embodiments of the invention, there is a method of assembling a tensile structural assembly comprising a base support, a guide hook, a loop and a tie, wherein said guide hook comprises a guide section and a hook section, and wherein the hook section comprises a sliding hook section capable of movement in relation to said guide section, and wherein said guide section and is fixed to said base support, wherein said loop is attached to or forms part of said tie, wherein said loop is retained by said guide hook, wherein said loop and said tie are in tensile stress, said method comprising the steps of
(i) fixing said guide section to said base support,
(ii) locating said loop over said hook,
(iii) locating said application tool against said sliding hook section, and
(iv) applying a force to said application tool which moves said sliding hook section along said guide section to a restraint, said movement imparting tension into said loop and said tie.

The tie is optionally a membrane tie, typically comprising a sheet of woven or non-woven fabric or filmic material, or a linear tie, for example an elasticated cable. An assembly comprising a membrane tie typically comprises a plurality of discrete connections to the base support, each discrete connection comprising a guide hook and a loop, in order to retain the membrane tie in tension in orthogonal directions.

Typically, the guide section is of substantially uniform width, and typically of substantially uniform cross-section, along its length.

Optionally, the guide section and the hook section
(i) are monolithic, in one piece, or
(ii) are separately formed and the hook section is capable of movement in relation to the guide section, the guide section being typically fixed to the base support, or
(iii) are separately formed but are typically fixed contiguously to the base support.

In a first embodiment of the invention, the guide section and hook section are monolithic.

Typically the guide hook serves as a guide to the application tool or to a fixture attached to the loop or to the tie. Typically the guide hook is fixed to the base structure, for example is screwed or bolted to a billboard structure or a building structure, for example to a brickwork wall, or to a compression member, for example a strut in a space structure, or a pole, for example a flag pole or a lamp pole or other street services pole, or to a vehicle, for example a truck or bus, for example to provide an advertisement tensile structure. The guide hook is typically metallic, for example of steel, stainless steel, aluminum or brass.

The application tool typically comprises two forked prongs, typically to be located on either side of the guide section of the guide hook. Typically, the maximum width between the two prongs is greater than the maximum width of the guide section of the guide hook. The end of each prong of the tool typically comprises a recess into which the loop is temporarily seated during the assembly process. Typically the prongs of the tool are retained in an application tool shaft or handle, which is optionally extended by means of a pole, for example which can be attached to the handle, for example by means of a sleeve screw or bayonet fixing, for example the tool handle comprising a sleeve into which the pole or an end fitting to the pole fits when it is required to extend the length of the application tool. Optionally, the application tool comprises two prongs of variable geometry, which are hinged or sprung, to be capable of being changed from an open position in order to be easily located over the guide section, to then be deflected inwards to bear directly against the sides of the guide section, the change in geometry being effected, for example, by the increasing tension in the loop as it is pushed along the guide section.

Optionally, a fabric or filmic membrane tie will have elastic properties, for example fabric comprising rubber elastic threads. Optionally, a fabric or filmic structure will have reinforced edges, for example a seam, optionally containing a cable. Optionally, a membrane tie comprises an open weave fabric (woven or non-woven) or mesh comprising a plurality of open areas enabling through vision, for example a white mesh, optionally having a black coating on one side, or a black mesh with a white coating on one side, to be imaged on the white side and seen through from the black side, for example to provide a one-way vision effect, for example as supplied by Ferrari, France, or Continental Grafix, Austria. Such see-through fabric can be tensioned across windows and optionally solid areas of a bus or building, to provide an overall advertisement or sign while maintaining the daylight in and view out properties of the window or windows behind the display, coupled with solar heat gain, UV and glare reduction properties, akin to panels according to U.S. Pat. No. RE37,186 (Hill) or U.S. Pat. No. 6,212,805 (Hill). An advantage of the present invention is that an advertising banner over windows, typically see-through, can be quickly removed for window cleaning, and quickly replaced after window cleaning, especially valuable on a bus which is typically washed in an automatic bus washing machine every day. During the washing of the bus, the advertisement is optionally positioned temporarily on a “washing wall” comprising guide hooks of the invention and optionally washed and optionally dried itself, before being replaced on the bus after the bus wash is completed.

A membrane tie typically comprises discrete fixing points, for example eyelet holes or gripper devices, for example Holdon™ two component grippers, one of the components comprising a wedge.

Preferably, each loop in an assembly comprises a highly elastic cord, sometimes referred to as “shock cord” or “bungee cord”, as this imparts additional advantages to one or more embodiments of the invention, for example a positive “snap back” feature when being located over the end of a guide hook. The elastic cord snaps back from the end of the hook section towards the base support when engaging with the hook section, typically accompanied by a distinctive noise which indicates that the required tensile fixing of the loop over the guide hook has been properly effected. The application tool is simultaneously released on snap back. The “snap back noise” is created by the laterally curved outer profile of the hook section stretching the elastic cable of the loop away from the recess in the guide hook, the elastic cable snapping back when reaching the end of the hook section, the elastic cable and/or the application tool being thrown against the base support or a part of the guide hook. Typically, the “snap back noise” is a clearly discernible signal against the background noise, for example of passing vehicular traffic noise or the noise of construction equipment on a construction site. Optionally, a “sounding device”, for example a thin piece of metal, forms part of or is attached to the base support or guide hook, to increase and further distinguish the snap back noise, for example a relatively high pitched noise against the lower pitched drone of passing traffic on a highway to which a billboard is adjacent.

In a first example of the first embodiment of the invention, a billboard tensile structure comprises a plurality of guide hooks fixed to a planar billboard structure, for example metallic hooks screwed to a timber or metal-faced timber sheet to which prior art printed billboard paper posters are otherwise applied. An elasticated loop is typically located over each hook guide, so tensioning a fabric or filmic membrane tie which is typically printed, for example polyethylene fabric printed with UV-cured ink, or PVC-coated polyester fabric printed with solvent or UV-cured ink.

In the prior art sequential fixing of tensile connection points is normally problematic. For example, if an initial number of connecting points are secured with a membrane tie in a slack condition, the required tension needs to be imparted or imposed into the membrane tie and all the discrete tensile connections when forming the residual tensile connections. The residual connections typically could not be made from a remote access position, as an application tool on a pole would have minimal lateral stability. The invention enables the membrane tie to be temporarily located in a relatively untensioned or slack condition onto the guide hook, when the required force can be applied in a controlled manner not requiring any lateral restraint to be imposed by the application tool or pole, which only requires an axial force to be applied. The guide section of the guide hook and the two-pronged application tool work together with the loop, typically enabling a much greater force to be applied to the loop to fix it over the hook section of the guide hook, with typically much higher residual tensile forces in the loop and tie than provided by prior art methods of fixing loops to restraining hooks. Optionally, when the loop is progressively pushed with the application tool along the guide section of the guide hook, the tension in the loop draws the two prongs into direct contact with the side of the guide section, providing the prongs can be so deflected, for example being unconnected at their ends and relatively flexible.

The guide section preferably eliminates the otherwise inevitable tendency of the end of an application tool to be laterally unstable, especially if affixed to the end of a pole. Stability in the direction perpendicular to the base support is provided by the angle of the application tool against the guide section or the base support to which the guide hook is fixed. Optionally, stability in this direction can be additionally provided by a recessed groove on one side or preferably both sides of the guide section of the guide hook, for example the guide section being a ‘T’ section or comprising a recess on each side or a section of the similar shape to a railway rail, into which lugs on the application tool, i.e. one or more sections projecting at on the application tool, are located. Optionally, the end of the guide section of the hook is tapered, to assist the initial locating of the application tool onto the guide section of the guide hook. Preferably, the guide section has projecting edges to resist wear and tear of the base support and to provide a smooth bearing surface for the two prongs being pushed up the guide section, for example similar to a rail section or a profiled section used to make door bolts. Preferably the side projections form a backplate to the guide hook which extends up to the end of and optionally beyond the hook section, to act as a receptor plate to the impacting application tool prongs upon snap back, optionally also acting as a sounding device. Typically, the longitudinal axis of the guide hook is aligned or orientated to allow an axial force to be applied to the handle of the application tool or any extension pole, from an access position below the billboard. Optionally, a swivel section or rotational capability can be incorporated into the end of the application tool, for example by means of a universal or ball joint, to enable a loop to be located over a guide hook by a force applied from a position which is not aligned with the longitudinal axis of the guide hook.

To release a loop from a guide hook, for example in dismantling a structure or replacing a tie, one of the application tool prongs is optionally located between one side of the loop and guide section of the hook and pushed towards the hook section until the loop is released. Preferably a purpose-made release tool is used, typically comprising an axial single prong with a single recess to support the loop cable.

Optionally, a projecting support is provided on the base support to eliminate or reduce flapping of the membrane tie, for example under windy conditions. The projecting support optionally has a surface of single or double curvature and is optionally a solid support, for example comprising a foam material, or is optionally a framework, for example a lattice of timber members, or optionally comprises discrete support positions, for example discrete hemispherical projections from the base structure.

Optionally the base support or a projecting support comprises a transparent material behind which illumination is provided, for example to provide a back-lit illuminated billboard sign on a billboard structure that was previously not illuminated.

In a second embodiment of the invention, the guide hook comprises a hook section which is moveable in relation to the guide section, typically by a sliding action along one axis, for example by adaptation of a sliding bolt action. In this embodiment, the loop is located over the hook and the hook is then pushed, thus extending and increasing the tension in the loop, until it reaches the end of travel or restraint on the guide section and is fixed in the extended position, for example by rotation of the guide hook or by the activation of a spring restraint mechanism. The pushing of the guide hook optionally is assisted by an application tool, for example to obtain extra “purchase” or pushing force than with just use of the hands, or for extended reach, for example at the top of a billboard. This embodiment has the advantage that the guide hook is restrained by the guide section both parallel to and perpendicular to the base support, for example by means of a slotted barrel, directing the application of the pushing force to extend and thereby tension the loop.

The tensile structures of one or more embodiments of the invention are typically temporary, for example comprising:

(i) a billboard assembly comprising an imaged membrane tie, and
(ii) a canopy, and
(iii) a flag pole, and
(iv) an advertisement assembly comprising a window.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is an elevation of a billboard structure.

FIG. 2 is a cross-section through the billboard structure of FIG. 1.

FIGS. 3A-D are elevations of guide hooks.

FIGS. 4A-D are longitudinal sections through guide hooks.

FIGS. 5A-F are cross-sections through alternative guide hook profiles.

FIG. 6 is an elevation of an eyelet hole in a membrane tie.

FIG. 7 is an elevation of a loop.

FIG. 8 is an elevation of a loop located in an eyelet hole.

FIG. 9A is a cross-section through a membrane gripper.

FIG. 9B is an elevation of a membrane gripper attached to a membrane tie.

FIGS. 10A-D are elevations of application tools.

FIG. 11A-E are sequential diagrams showing the application of a loop attached to a membrane tie over a guide hook in side elevation.

FIG. 12A-E are sequential diagrams showing the application of a loop attached to a membrane tie over a guide hook in front elevation.

FIG. 13A is a longitudinal section through a guide section.

FIG. 13B is a plan of a guide section.

FIGS. 14A and B are cross-sections through a guide section.

FIG. 15A is an end elevation of a sliding bolt hook section.

FIG. 15B is a side elevation of a sliding bolt hook section.

FIG. 15C is an end elevation of a sliding bolt hook section.

FIG. 15D is a side elevation of a sliding bolt hook section.

FIGS. 16A-E are sequential plan diagrams illustrating the operation of a guide hook with a sliding bolt hook.

FIG. 17 is a cross-section through a billboard structure comprising a projecting support.

FIG. 18 is an elevation of a tensile structure canopy between two buildings.

FIG. 19 is a plan of a tensile structure canopy between two buildings.

FIG. 20 is an elevation of a flag-pole structure.

FIGS. 21A and B are elevations of a removal tool.

FIG. 22 is an elevation of a membrane tie.

FIGS. 23A and B are elevations of a billboard structure.

FIGS. 23C and D are cross-sections through the billboard structure of FIGS. 23A and B.

### DETAILED DESCRIPTION OF EMBODIMENTS OF THE INVENTION

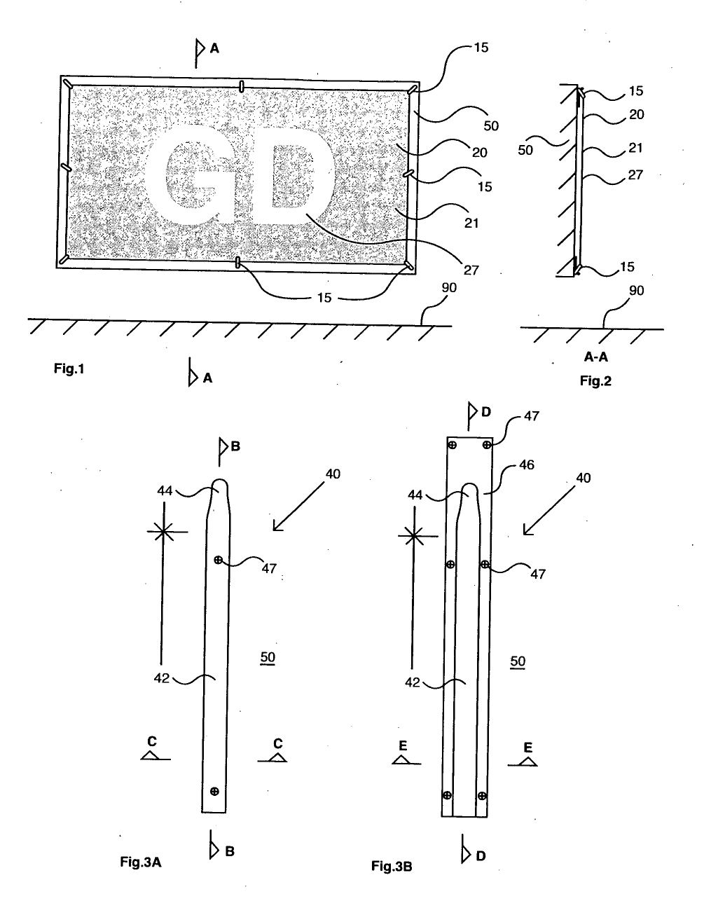

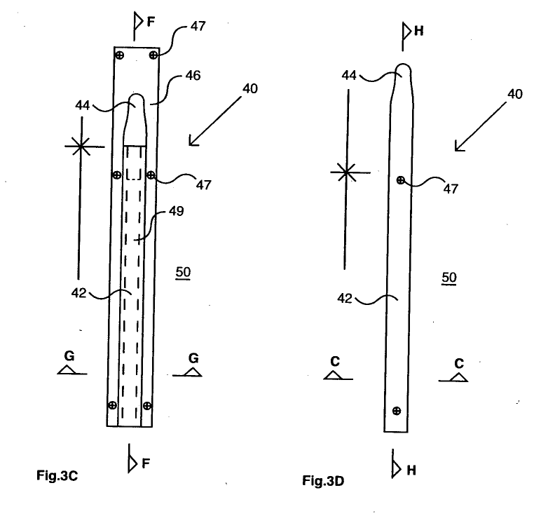

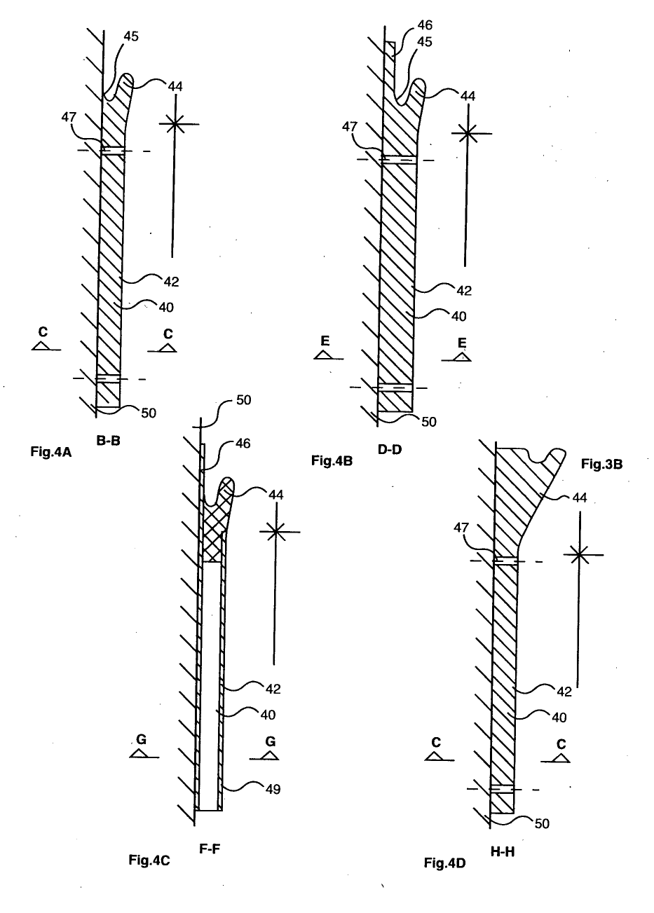

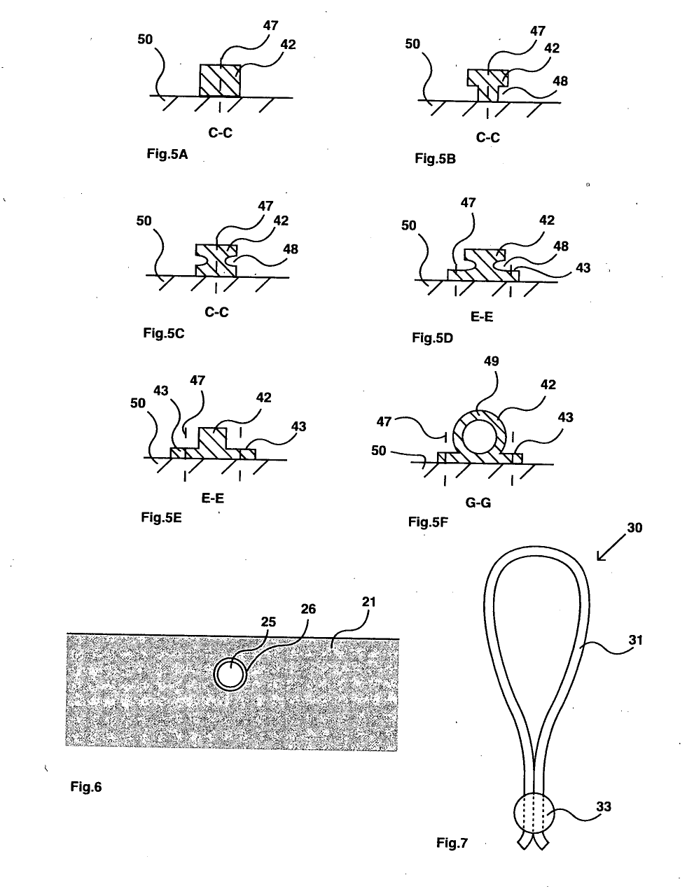

FIG. 1 is an elevation of a billboard tensile structure comprising base support 50 with tie 20, being a membrane tie 21 comprising graphic design 27 fixed to the base support 50 by means of discrete connections 15, which may be effected from access area 90, as also shown in cross-section in FIG. 2. The discrete connections 15 comprise a guide hook 40, examples shown in elevation in FIGS. 3A-D, fixed to base support 50 by means of screws in screw holes 47. In FIG. 3A, the guide hook 40 comprises a guide section 42, typically of substantially uniform cross-section, and a hook section 44. This guide hook is also illustrated in longitudinal section B-B in FIG. 4A. Preferably the hook section 44 comprises an upstand 45 against the base support, so that the loop cord is fixed without becoming trapped between the guide hook and the base support. Optionally upstand 45 is extended to form an upstand plate 46 to resist wear and tear on the base support 50, as shown in FIG. 3B and FIG. 4B, and optionally to also make a “snap back noise” more distinctive, for example of thin cross-section to emit a high pitched noise when vibrating upon snap back of the elastic loop. FIG. 3C and FIG. 4C also show an optional guide hook construction of a guide section 42 comprising a bolt barrel profile into which a hook section is fixed, for example by means of adhesive or metallic heat treatment, by heating the bolt barrel section, inserting the close fit hook section and cooling the assembly to provide a strong grip of the hook section. FIGS. 3D and 4D show a guide hook in which the hook section 44 protrudes from the base support 50 such that the tensioned loop and membrane tie (both not shown) would be clear of the guide section 42, when tensioned. FIGS. 5A-F are example cross-sections of the guide section of the guide hook, being a rectangular section in FIG. 5A. Guide sections optionally comprise one or more recesses, for example the “T” section in FIG. 5B, a section with side recesses 48 in FIG. 5C and a rail-like section in FIG. 5D. In such guide sections comprising a recess, the application tool typically comprises a lug which is located within the recess in one side of the guide section. The rail section of FIG. 5D, the inverted ‘T’ section in FIG. 5E and the bolt barrel section of FIG. 5F all comprise side runners 43 on which the application tool prongs can slide, to prevent wear and tear of the base support 50. FIG. 6 illustrates fabric or filmic membrane tie 21 with an eyelet hole 25, typically with a metal annular or “ring” reinforcement 26, for example through which optional loop 30 in FIG. 7 is positioned and restrained by loop anchor 33, for example a bobble or toggle, as shown in FIG. 8. Preferably, loop 30 comprises elastic cord 31, sometimes referred to as shock cord or bungee cord.

The membrane tie 21 optionally has significant elastic properties itself and optionally eyelet hole 25 comprises the loop according to an alternative embodiment of the invention.

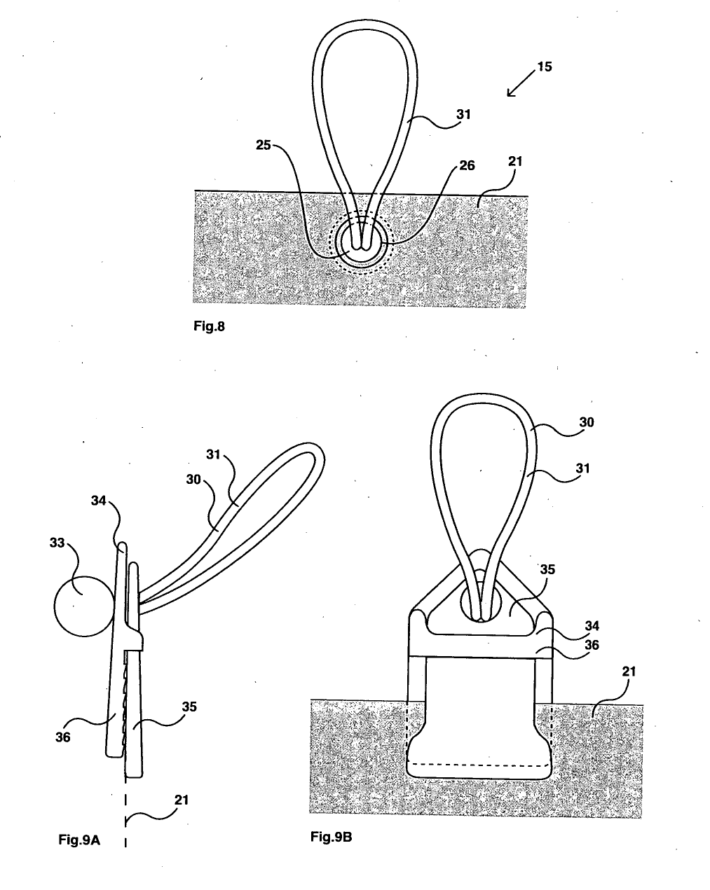

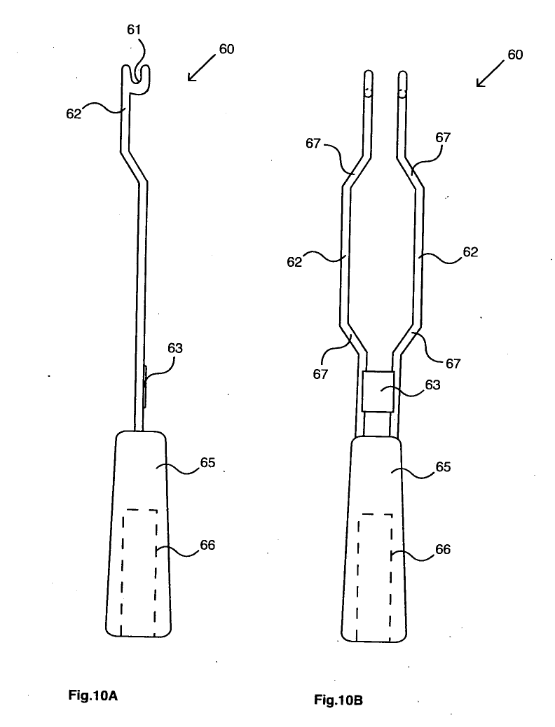

As another example of a discrete connection, FIG. 9A illustrates loop 30 passing through holes in a membrane gripper 34, comprising wedge section 35 and holding section 36, optionally serrated, for example a Holdon™ gripper supplied by Holdon™, which grips membrane tie 21, as also illustrated in FIG. 9B. The holes in wedge section 35 and holding section 36 are offset so that tensioning of loop 30 imparts an increased wedging force of wedge section 35 onto the trapped membrane tie 21.

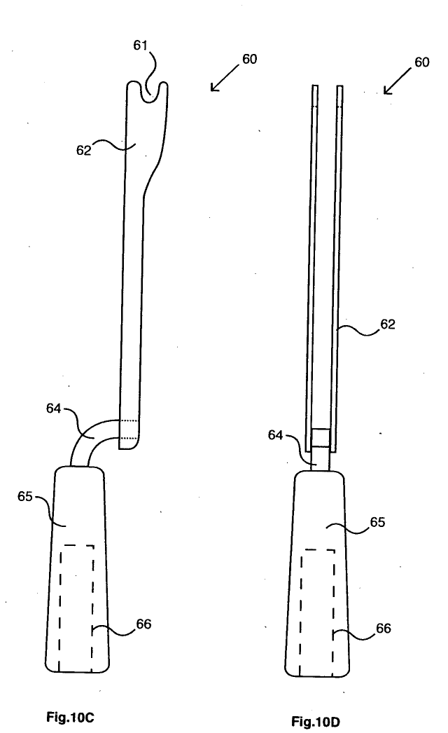

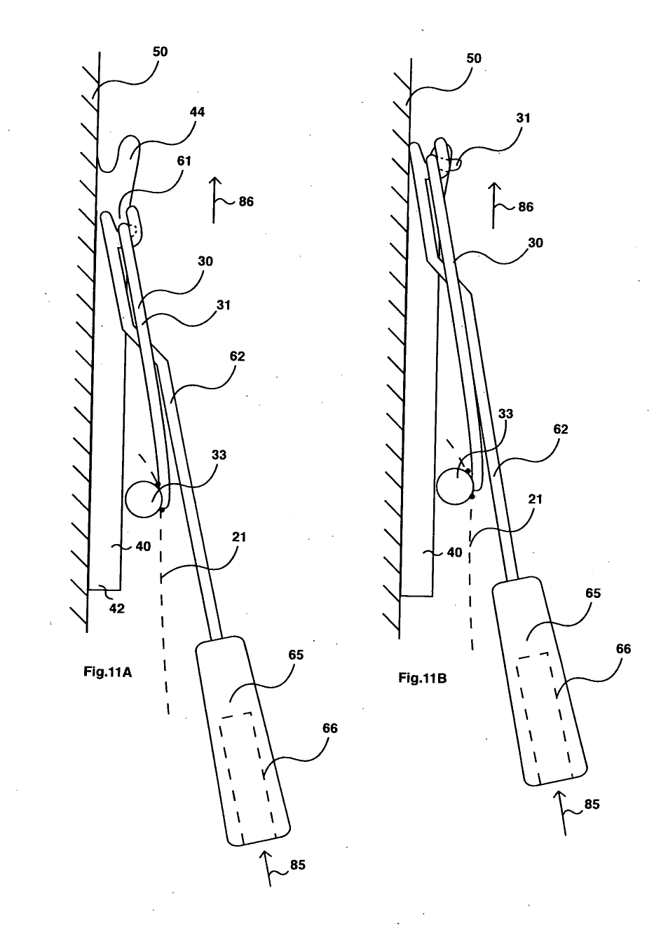

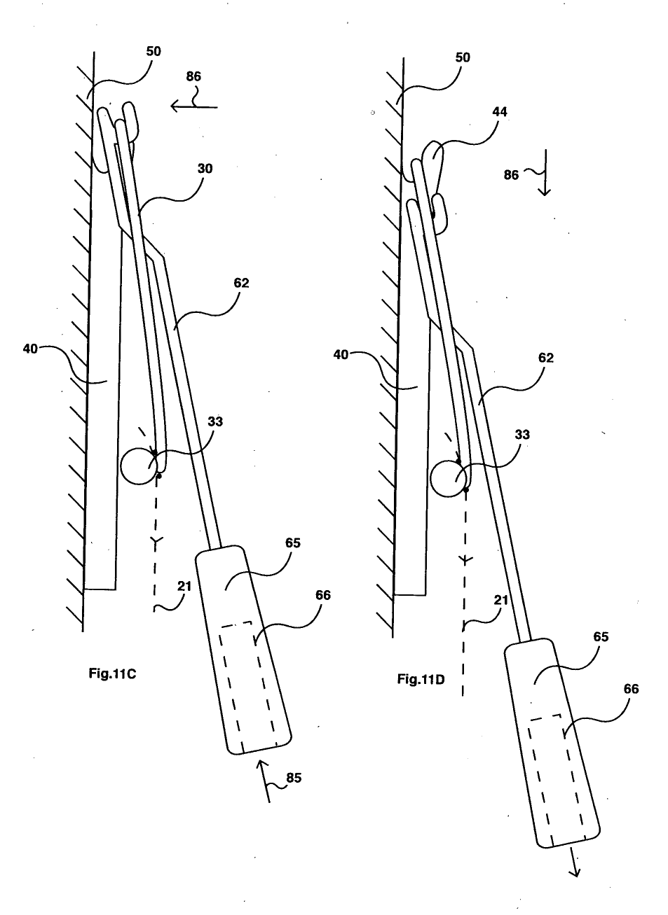

FIG. 10A illustrates an application tool 60. The prongs 62, for example manufactured from steel rod, each comprise prong recess 61 in which the loop sits during the application process. The prongs 62 optionally, comprise bridge 63 and are optionally also bridged towards the end of the prongs (not shown). Optional 5, handle 65 typically comprises recess 66, for example for a screw or bayonet optional fixing to an extension pole (not shown), to enable remote fixing of a loop over a guide hook. Alternatively, the extension pole comprises a sleeve to surround the handle of application tool 60 in order to provide an extension capability. FIG. 10B is a front elevation of the same application tool 60 as FIG. 10A, showing splayed portions 67 of prongs 62, which enable the application tool to straddle a wide range of fixing devices during the application process. FIGS. 10C and 10D are side and front elevations of a different application tool 60 fabricated from steel plate comprising prongs 62, each comprising prong recess 61 and joined by shaft 64, for example by welding. Depending on the height of the access area in relation to individual discrete connections in the tensile structure, application tools of alternative design or layout are optionally provided, for example if the lower edge of a billboard tensile structure is above head height from the access area, the prong recess 61 of the application tool, in fixing the lower connections, is preferably downward facing, to enable a pulling action to be adopted rather than a pushing action.

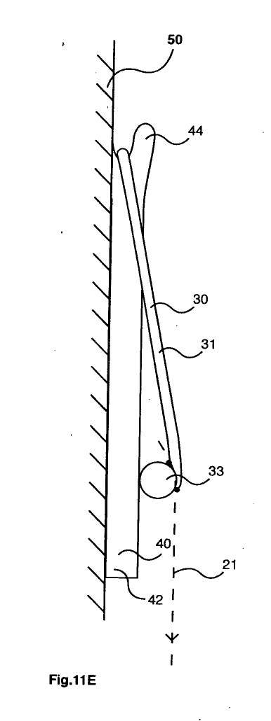

FIGS. 11A-E illustrate the tensioning and application of loop 30 to guide hook 40 fixed to base support 50 after the loop 30 has been located within the recess 61 of prongs 62 and prongs 62 have been located to either side of guide section 42 of guide hook 40. A substantially axial force 85 applied to handle 65, either directly by hand or via an extension pole (not shown), pushes the elastic loop along the guide section 42 in movement direction 86 in FIG. 11A, and onto the outside of the hook section 44, in FIG. 11B, in which elastic cord 31 is shown stretched sideways away from prong recess 61, the end of prongs 62 typically bearing against base support 50. In FIG. 11C, further upward movement in direction 86 causes the loop 30 to reach the top of hook section 44, when the ends of prongs 62 are typically forced away from base support 50 until the elastic cord snaps back towards base support 50 in movement direction 86. The snapping action of the elastic cord 31, akin to the action of a catapult, typically throws the prongs 62 against the base support 50 making a distinctive noise by virtue of the release of this elastic energy, including the noise of impact of prongs 62 against base support 50. This snap back feature of the invention assists the postitive location of loop 30 around hook section 44 and simultaneously releases the application tool from the guide hook as shown in FIG. 11D. FIG. 11E shows the complete installation of loop 30 to guide hook 40, elastic cord 31 and membrane tie 21 being in tension.

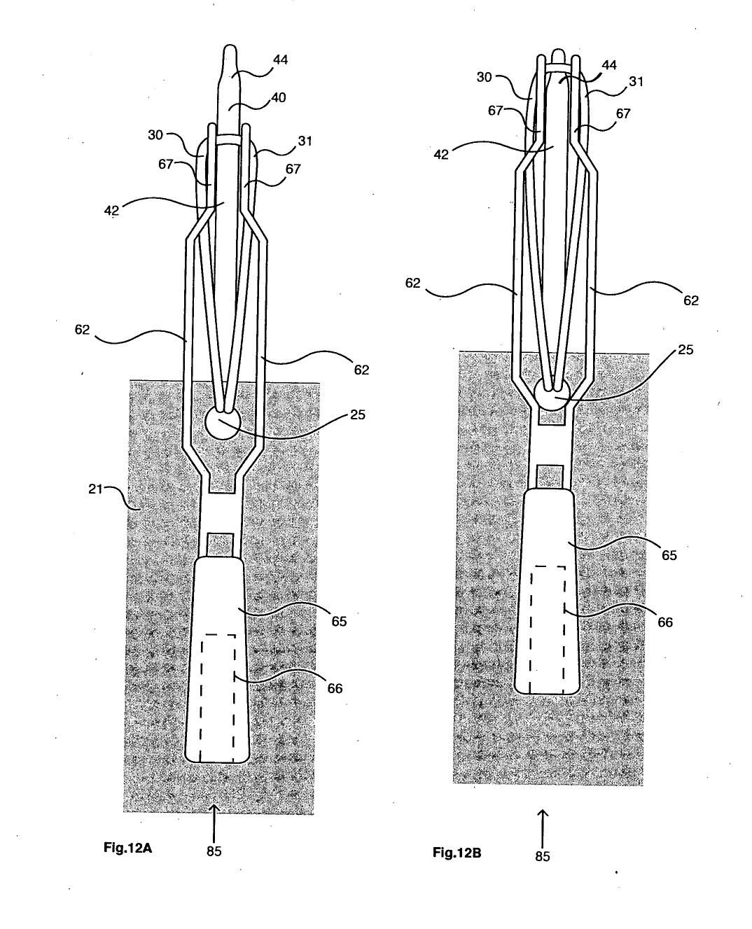

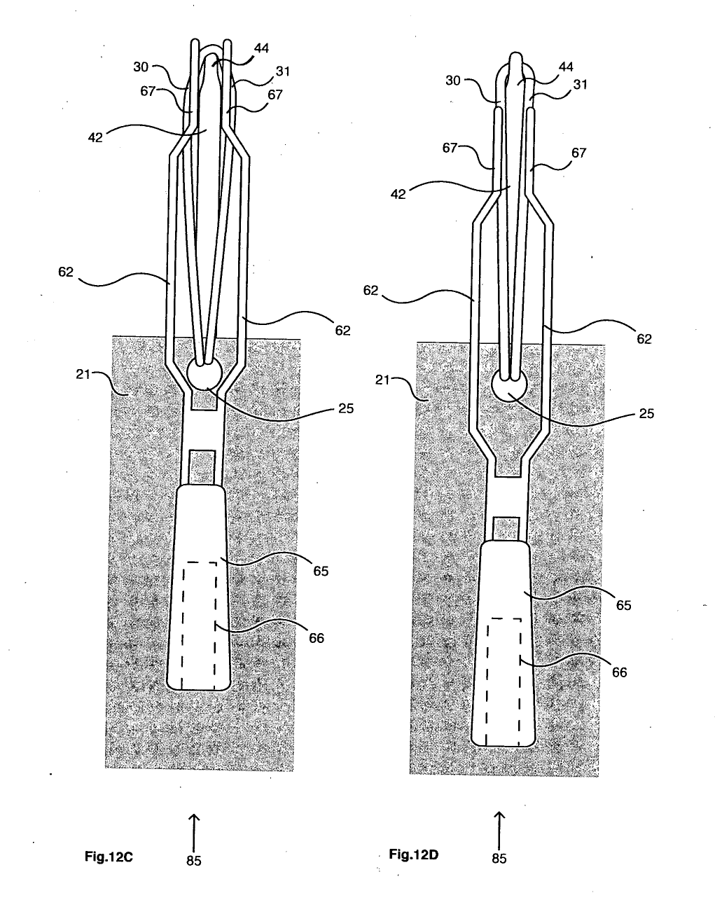

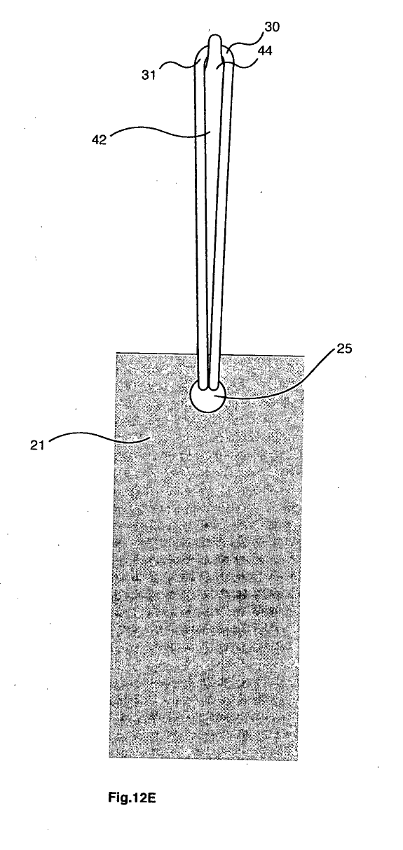

FIGS. 12A-E are front elevations of the same stages as FIGS. 11A-E.

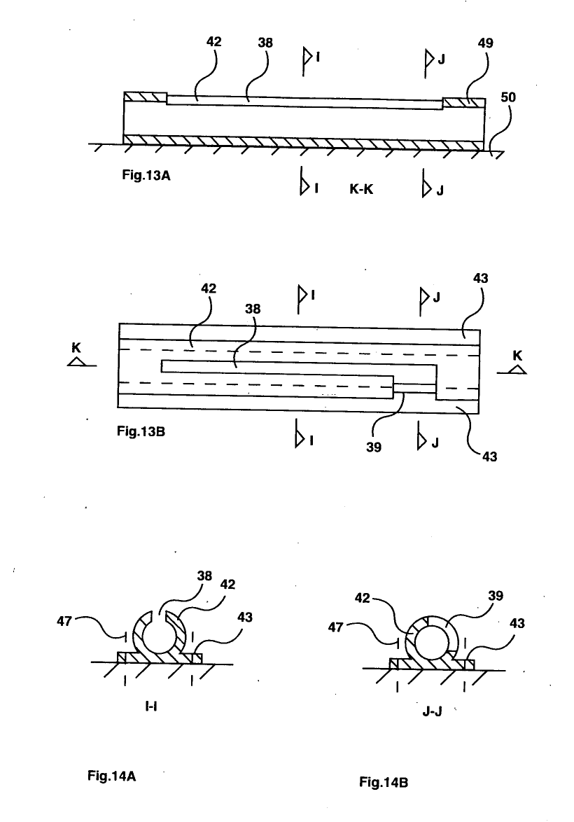

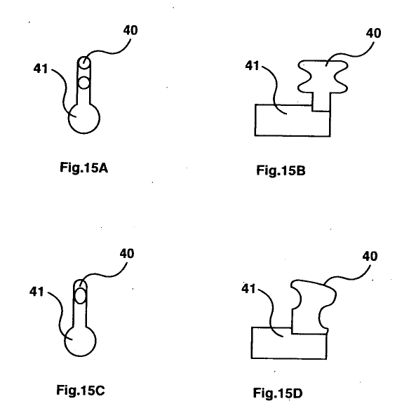

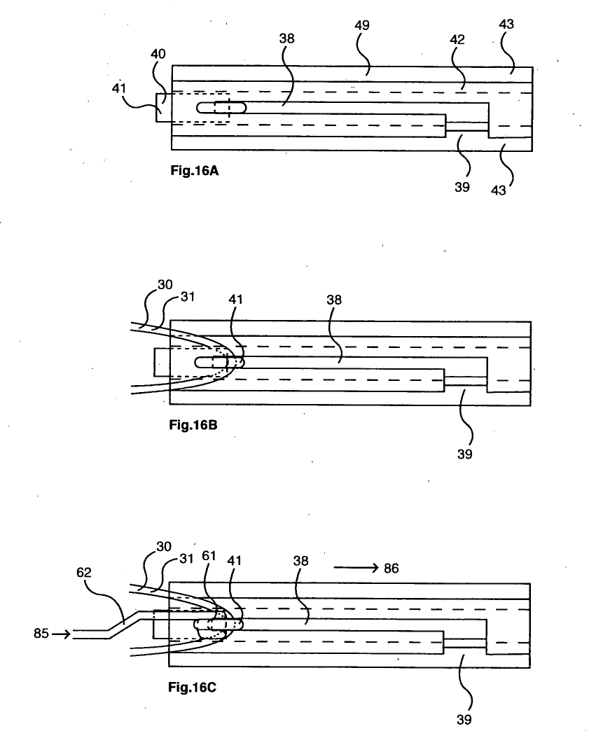

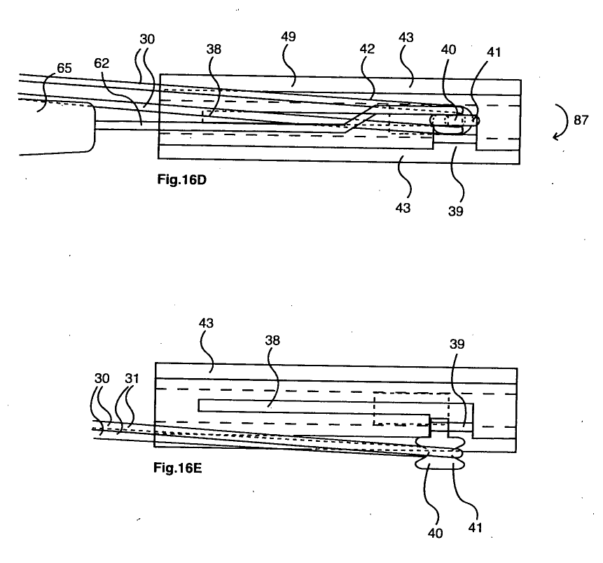

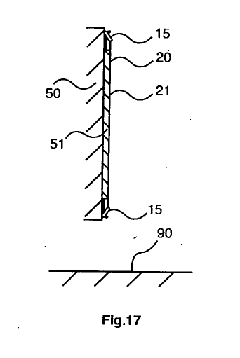

FIGS. 13A to 16E illustrate a guide hook embodiment comprising a sliding hook 41, optionally sliding within a standard or special bolt barrel profile 49 similar to FIG. 5F, suitably slotted to retain and guide the sliding hook section 41. FIG. 13A is a longitudinal section through the guide section 42 comprising bolt barrel profile 49 with longitudinal slot 38, also shown on plan in FIG. 13B with side slot 39 providing an optional means of restraining the sliding guide hook 41, at the end of its travel along the guide section 42, also shown in cross-sections I-I and J-J in FIGS. 14A and 14B. Examples of guide hooks are shown in end and side elevations in FIGS. 15A and B and FIGS. 15C and D. FIGS. 16A-E illustrate the sequential tensioning and fixing of loop 30, for example comprising elastic cord 31 as illustrated in FIG. 7. Sliding hook section 41 is located partially within bolt barrel profile 49 and guided within longitudinal slot 38. Loop 30 is shown located over sliding hook section 41 in FIG. 16B. The sliding hook section is optionally moved manually or with the aid of an application tool. FIG. 16C shows the prong recess 61 of an application tool prong 62 located behind the sliding hook section 41 and force 85 being applied causing movement of sliding hook section 41 along longitudinal slot 38 in direction 86 until it reaches a restraint, for example side slot 39 as illustrated in FIG. 16D, where the sliding guide hook 41 is rotated, optionally by means of the application tool, in direction 87. FIG. 16E shows the sliding guide hook 41 restrained by the edge of slide slot 30 with the elastic cord 31 of loop 30 in tension. Optionally, sliding hook 41 can be retained at the end of longitudinal slot 38 by other means, for example sprung restraints known in the art. This sliding guide hook embodiment has the advantage of providing restraint perpendicular to as well as in the plane of the base support, for example enabling the tensioning force to be applied at an angle to the guide section 42. Optionally, the sliding hook section 41 can be moved manually within the bolt profile to tension the loop, in a manner much safer than trying to manually tension an elasticated loop over a fixed hook without any such directional guidelines.

FIG. 17 is a cross-section through a billboard tensile structure similar to FIG. 2 but comprising optional projecting support 51 located between base support 50 and membrane tie 21, for example to assist the provision of a smooth surface to membrane tie 21 and reduce any tendency of membrane tie 21 to flap, for example under wind loading. Projecting support 51 is optionally of single curvature or optionally of double curvature, the latter requiring a membrane tie with sufficient elastic or plastic deformation properties to accommodate the double curvature. The projecting support 51 is optionally a solid support, for example comprising a foam material, or is optionally a framework, for example a lattice of timber members, or optionally comprises discrete support positions, for example discrete hemispherical projections from the base structure. Optionally the projecting support comprises a transparent material behind which illumination is provided, for example to provide a back-lit illuminated billboard sign on an existing billboard structure that was previously not illuminated. Optionally, a surrounding frame can be provided to mask the discrete connections 15 and projecting support edges.

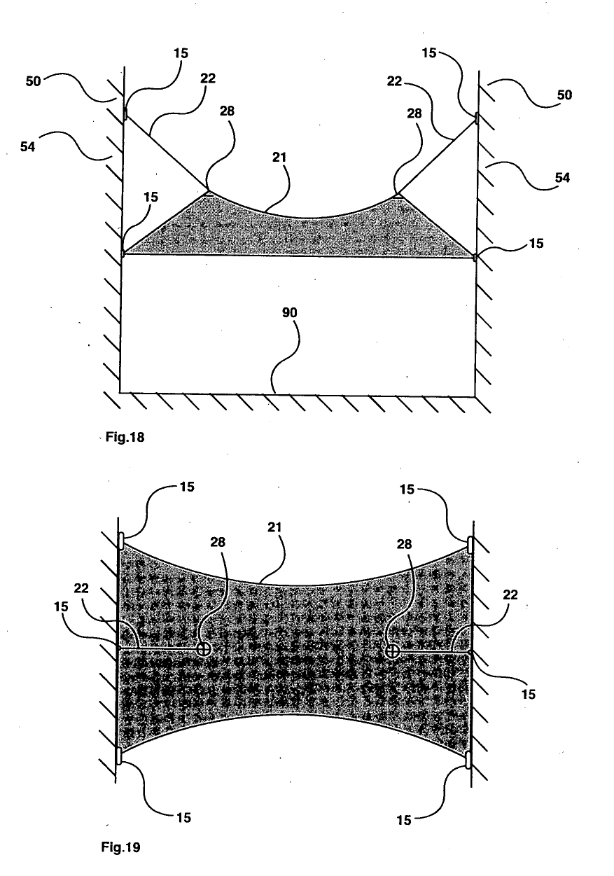

FIGS. 18A and B show a canopy tensile structure comprising membrane tie 21 covering an access area 90 between buildings 54 comprising wall base supports 50. Membrane tie 21, for example of Teflon® or PVC-coated polyester fabric, is fabricated by methods known in the art of tensile structures, into a double curvature shape to be tensioned to form a stable structure. The membrane tie 21 and linear ties 22 are connected to base support 50 by means of discrete connections 15, for example as illustrated in FIGS. 15A-E and FIGS. 16A-E. Linear ties 22 are also connected to membrane tie 21 at reinforced connectors 28 by constructional details known in the art of tensile structures. Such canopies are typically temporary, for example to cover a barbecue area, or semi-permanent, for example to provide a covered walkway between two buildings. Various embodiments of the invention can be used in a wide variety of tensile structures, of many optional structural forms and materials.

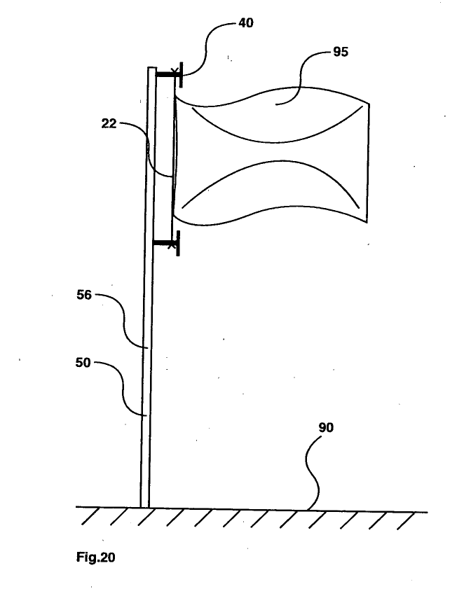

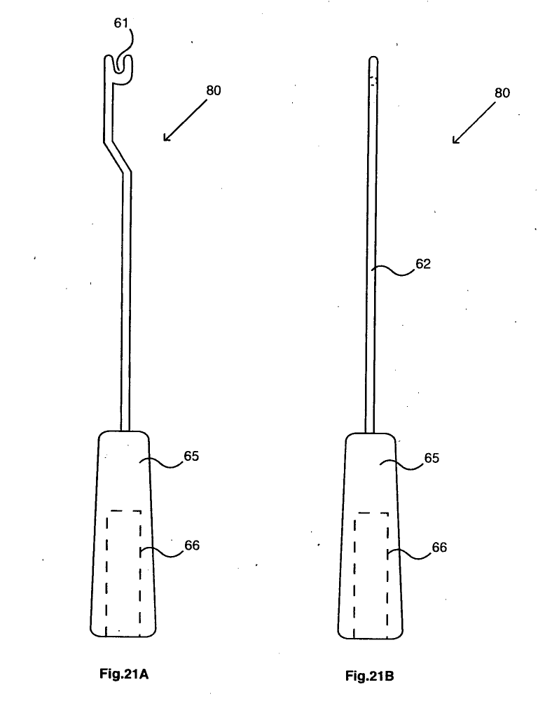

FIG. 20 illustrates a flag hoisting system comprising flag 95, for example a conventional printed fabric flag, flagpole 56, for example of timber or metal tube and comprising base support 50, linear tie 22, for example elastic cord, and guide hook 40. Optionally, guide hook 40 is fixed directly to flagpole 56 or is on projecting arms, for example of steel or brass. Such projecting arms can be made the width of a membrane tie, for example forming a vertical banner attached to a street lamp pole.

Dismantling structures of the invention or replacing a tie typically involves locating one prong of an application tool between the loop and guide hook and pushing the loop until disengaged from the guide hook. Optionally a purpose-made removal tool 80 can be used for this purpose, for example as illustrated in FIGS. 21A and B, comprising a single prong 62 with prong recess 61, handle 65 and recess 66 to enable an extension pole to be affixed. For example, in replacing an imaged membrane tie with one graphic design with another imaged membrane tie with another graphic design, the imaged membrane tie is removed and another imaged membrane tie is installed, wherein the removal comprises removing the loop from the guide hook by a prong of the application tool or a release tool, and the another imaged membrane tie and another loop is installed, the method of installing said another imaged membrane tie comprising the steps of:
(i) temporarily locating said another loop in said application, tool recess,
(ii) temporarily locating said application tool over said guide section,
(iii) applying a force to said application tool which moves said another loop along the guide section imparting tension into said another loop and said another imaged membrane tie, until said another loop is moved to the end of said hook section and snaps back within said hook section, retaining said another loop and said another imaged membrane tie in tension.

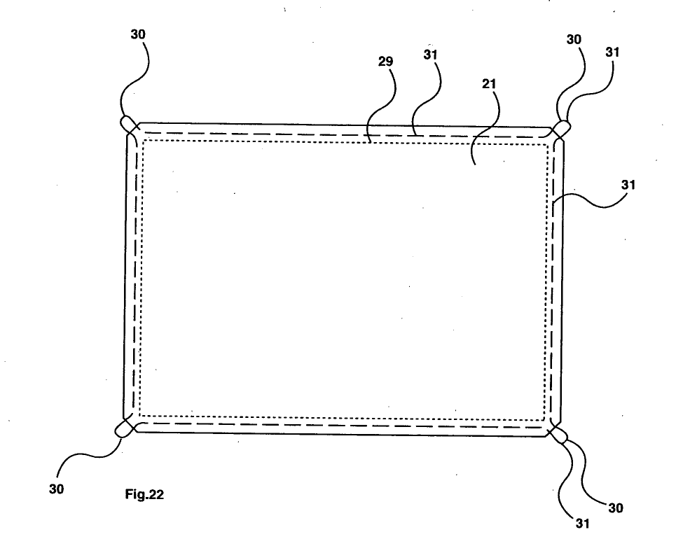

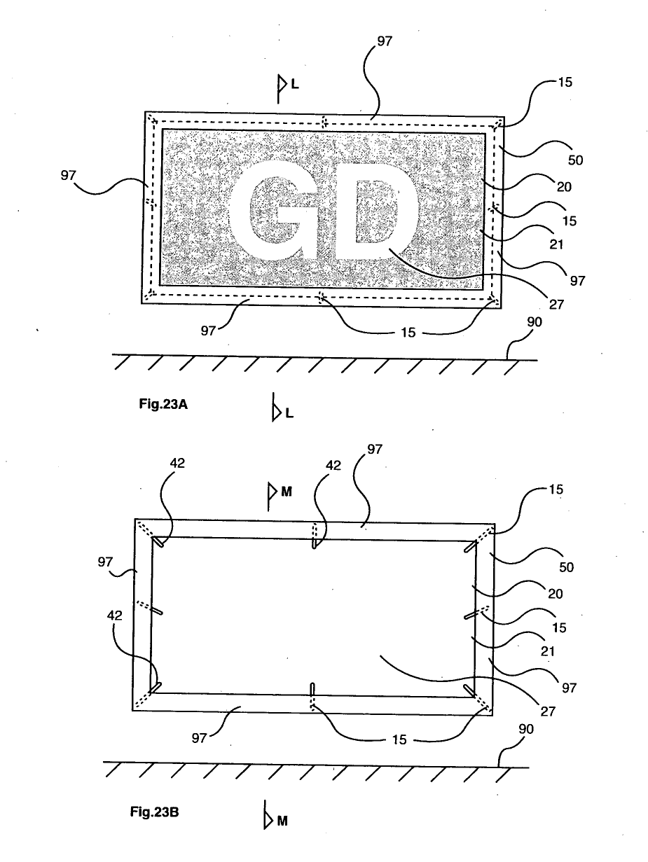

FIG. 22 illustrates a membrane tie 21, comprising perimeter seams 29 containing cord 31, preferably elastic cord, which forms corner loops 30 at discontinuities in the seam 29. Optionally additional loops are provided at discrete seam discontinuities at any point along the sides of membrane tie 21. The loops 30 are connected to guide hooks as previously described to form a tensile structure of the invention.

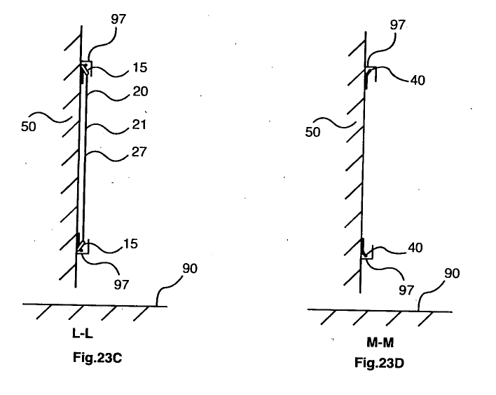

Optionally, for example in a billboard tensile structure of FIG. 23A, the edge of the membrane tie 21, the loops and any eyelet holes or grippers of discrete connections 15 are masked by a perimeter cover or frame 97 in order to provide a neat appearance to the finished billboard. If prior art hooks were used to restrain the loops, these prior art hooks would also typically be masked by the surrounding frame 97 prior to fixing of the membrane tie 21, causing difficulty in identifying their location. However, a significant advantage of the present invention is that, as illustrated in FIG. 23B, the guide section 42 of the guide hook typically protrudes from the inner edge of the frame, to be clearly visible prior to installation of the membrane tie 21, which enables easy location of the guide hook and fixing of the loop. The surrounding perimeter frame covers the hook section but does not cover all of the guide section.

Optionally, there is selective use of the invention on just one of the opposing sides being tensioned (two sides out of four for a rectangular membrane tie or one side if an alternative tensioning system is being used in one direction).

Guide hooks are typically of relatively short length, for example from 2-12 in. (50-300 mm). However, they can be of any length to suit the degree of convenience required in locating the application tool over the guide section, for example they may run the full height of a flagpole or billboard, for example using a progressively extendable pole, for example a telescopic pole, for ease of transporting application tools.

One or more embodiments of the invention reduce the risk of finger trap injury of manual application of loops to hooks while substantial tensile forces are being manually resisted. One or more embodiments of the invention also enable loops to be applied to guide hooks in positions remote from erector access positions, for example billboards can be posted from an access area at ground level or on an access platform immediately below a billboard without requiring ladder access. Ladders can be a safety risk to erectors, especially when applying a substantial force, for example to effect a tensile connection when supported on a ladder rung. Similarly, canopy tensile structures can be erected from ground level, for example affixed to guide hooks on a building or buildings, for example to provide an infill walkway canopy between two buildings. As another example, flags and banners can be fixed to poles with shock or bungee cord, reducing or eliminating the need for rope and pulley arrangements at ground level where they are liable to vandalism.

One or more embodiments of the invention provide a simpler, safer and more economic tensile structural system than prior art systems, for example of forming a billboard structure and replacing membrane ties comprising billboard advertisements at frequent intervals.

One or more embodiments of the invention enable the adoption of environmentally friendly materials, for example polyethylene fabric printed with UV-cured ink, which can be recycled after use, compared to prior art systems, for example self-adhesive PVC film printed with solvent-based PVC inks, which are very undesirable materials, requiring landfill with the attendant chemical migration problems of PVC.

In summary, various embodiments of the invention can be used in many different types of tensile structures and the embodiments illustrated are not limitive. The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

1. A tensile structural assembly comprising:
a base support,
a guide hook,
a loop, and
a tie,
wherein said guide hook is fixed to said base support,
wherein said guide hook comprises a guide section and a hook section, wherein said guide section comprises an elongate section,
wherein said loop is attached to or forms part of said tie,
wherein said loop is retained by said guide hook, and
wherein said loop and said tie are in tensile stress.

2. An assembly as claimed in claim 1, wherein said guide section comprises a length of substantially uniform width.

3. An assembly as claimed in claim 1, wherein the guide section and the hook section:
(i) are monolithic, or
(ii) are separately formed and the hook section is capable of movement in relation to the guide section, the guide section being fixed to the base support, or
(iii) are separately formed but are fixed contiguously to the base support.

4. An assembly as claimed in claim 1, wherein said assembly comprises a plurality of discrete connections to said base support, and wherein said plurality of discrete connections each comprise a guide hook and a loop.

5. An assembly as claimed in claim 1, wherein said tie is a membrane tie.

6. An assembly as claimed in claim 1, wherein said tie is a linear tie.

7. An assembly as claimed in claim 1, wherein said loop comprises elastic cord.

8. An assembly as claimed in claim 5, wherein said membrane tie comprises an eyelet hole to which is attached said loop.

9. An assembly as claimed in claim 5, wherein said membrane tie is attached to said loop by a membrane gripper.

10. An assembly as claimed in claim 1, wherein said guide hook comprises a sliding hook section.

11. An assembly as claimed in claim 10, wherein said sliding hook section is located partially within a bolt barrel profile and is capable of movement along a longitudinal slot in said bolt barrel profile to a restraint.

12. An assembly as claimed in claim 11, wherein said restraint comprises a side slot, and wherein said sliding hook section is capable of rotation into said side slot to maintain said tie in tension.

13. An assembly as claimed in claim 1, wherein said assembly comprises one of:
(i) a billboard assembly comprising an imaged membrane tie, and
(ii) a canopy, and
(iii) a flag pole, and
(iv) an advertisement assembly comprising a window.

14. An assembly as claimed in claim 13, wherein said assembly comprises a billboard assembly and wherein said billboard assembly comprises a surrounding perimeter frame which covers said hook section but does not cover all of said guide section.

15. A method of assembling a tensile structural assembly comprising a base support, a guide hook, a loop and a tie, wherein said guide hook is fixed to said base support, wherein said guide hook comprises a guide section and a hook section, wherein said guide section comprises an elongate section, wherein said loop is attached to or forms part of said tie, wherein said loop is retained by said guide hook, and wherein said loop and said tie are in tensile stress, wherein said method uses an application tool comprising a recess, said method comprising:
(i) fixing said guide hook to said base support,
(ii) temporarily locating said loop in said application tool recess,
(iii) temporarily locating said application tool over said guide section, and
(iv) applying a force to said application tool which moves the loop along the guide section imparting tension into said loop and said tie, until said loop is moved to the end of said hook section and snaps back within said hook section, retaining said loop and said tie in tension.

16. A method as claimed in claim 15, wherein said guide section comprises a length of substantially uniform width.

17. A method as claimed in claim 15, wherein said application tool comprises two prongs, wherein the maximum width between said two prongs is greater than the maximum width of said guide section of said guide hook.

18. A method as claimed in claim 17, wherein said prongs are deflected inwards to bear directly against said guide section.

19. A method as claimed in claim 15, wherein said application tool is capable of extension.

20. A method as claimed in claim 15, wherein a cross-section of said guide section comprises a recess in one side of said guide section.

21. A method as claimed in claim 20, wherein said cross-section is ‘T’ shaped.

22. A method as claimed in claim 15, wherein said loop comprises elastic cord.

23. A method as claimed in claim 22, wherein said elastic cord snaps back from the end of said hook section towards said base support when engaging with said hook section.

24. A method as claimed in claim 23, wherein the snap back is accompanied by a noise.

25. A method as claimed in claim 24, wherein said noise is distinguishable from vehicular traffic noise.

26. A method as claimed in claim 15, wherein said tie is a membrane tie.

27. A method as claimed in claim 15, wherein said tie is a linear tie.

28. A method as claimed in claim 20, wherein said application tool comprises a lug which is located within said recess in one side of said guide section.

29. A method as claimed in claim 15, wherein said application tool comprises a swivel section.

30. A method as claimed in claim 15, wherein said loop is subsequently removed from said guide hook by a single prong of said application tool or a release tool.

31. A method as claimed in claim 26, wherein a projecting support is located between said base support and said membrane tie.

32. A method as claimed in claim 26, wherein said membrane tie comprises a perimeter seam containing a cord, said cord comprising said loop at a discontinuity in said perimeter seam.

33. A method as claimed in claim 15, wherein said assembly is one of:
(i) a billboard assembly comprising an imaged membrane tie, and
(ii) a canopy, and
(iii) a flagpole, and
(iv) an advertisement assembly comprising a window.

34. A method as claimed in claim 33, wherein said imaged membrane tie is removed and another imaged membrane tie is installed, wherein said removal comprises removing said loop from said guide hook by a prong of said application tool or a release tool, wherein said another imaged membrane tie and another loop is installed, said method of installing said another imaged membrane tie comprising the steps of:
temporarily locating said another loop in said application tool recess,
(ii) temporarily locating said application tool over said guide section,
(iii) applying a force to said application tool which moves said another loop along the guide section imparting tension into said another loop and said another imaged membrane tie, until said another loop is moved to the end of said hook section and snaps back within said hook section, retaining said another loop and said another imaged membrane tie in tension.

35. A method of assembling a tensile structural assembly comprising a base support, a guide hook, a loop and a tie, wherein said guide hook comprises a guide section and a hook section, and wherein the hook section comprises a sliding hook section capable of movement in relation to said guide section, and wherein said guide section and is fixed to said base support, wherein said loop is attached to or forms part of said tie, wherein said loop is retained by said guide hook, wherein said loop and said tie are in tensile stress, said method comprising the steps of:
(i) fixing said guide section to said base support,
(ii) locating said loop over said hook,
(iii) locating said application tool against said sliding hook section, and
(iv) applying a force to said application tool which moves said sliding hook section along said guide section to a restraint, said movement imparting tension into said loop and said tie.
